(19) United States
(12) Patent Application Publication
(10) Pub. No.: US 2014/0250848 A1
(43) Pub. Date: Sep. 11, 2014

(54) Filter Media

(71) Applicant: SOUTHERN FELT COMPANY, INC., North Augusta, SC (US)

(72) Inventors: Eric W. Winters, North Augusta, SC (US); Michael Konesky, Evans, GA (US); William H. Moore, Martinez, GA (US); Michael A. Sudduth, Aiken, SC (US)

(73) Assignee: Southern Felt Company, Inc., North Augusta, SC (US)

(21) Appl. No.: 13/794,319

(22) Filed: Mar. 11, 2013

(51) Int. Cl. B01D 39/16; B01D 39/20

(52) U.S. Cl. CPC B01D 39/1623; B01D 39/2017; B01D 39/2041
USPC 55/528

(57) ABSTRACT

A nonwoven filter media comprising: polyphenylene sulfide fibers, an inorganic fibers wherein said filter media exhibits physical properties taken from the group consisting of: (a) a clean gas concentration of less than 0.1 mg/m³, (b) an average cycle time of greater than 125 seconds when the media at 16.0 ounces per square yard is tested per ASTM-D6830-02, (c) residual pressure drop of less than 350 Pa as measured by ASTM-D6830-02; (d) weight of between 5.0 and 20.0 ounces per yard² and a thickness between 0.020 and 0.100 inches, (e) air permeability of between 10 and 60 cubic feet per minute, (f) Mullen Burst strength of 225 lbs/inch², (g) less than 50% strength loss according to a tensile test after being submerged in sulfuric acid according to test ASTM-D461-93, (h) total mass removal efficiency of 99.99% and (i) resists burn-through by a stainless steel ball bearings heated to 800° C.

### FIELD OF THE INVENTION

This invention is directed to a filter media with improved heat resistance and performance properties, specifically, a filter media with improved cycle times, particulate removal efficiency, heat resistance and chemical resistance.

### BACKGROUND OF THE INVENTION

In several industries, baghouses having bag filters are used to remove dust and other particulates from the an air stream. Some of the industries that use bag houses to remove particulates from the air stream include garbage incinerators, coal plants or boilers, furnaces for melting metal and other materials, pharmaceutical production food manufacturing, chemical production and cement plants.

Most baghouses use long, cylindrical filter bags or tubes made of fabric as the filter medium. Gas having particles enters the baghouse through hopper (10 of FIG. 1) which generally is a large funnel-shaped containers used for collecting and dispensing the particulate. The gas is then directed through the filter bags 12 in a manifold where the filtered air exits the baghouse. Particulate in the gas stream are deposited on the filter bag. Periodically, compressed air or other means is used to reverse the flow of gas through the bag filter which results in the filter cake or particulates being forced off the filter bags. The particulate then drops to the bottom of the hopper and can be removed from the hopper. The particulates collect on the bag due to at least one of the following forces: inertial collection, interception, Brownian movement and electrostatic forces.

Depending upon the industry and application of the baghouse, the operating temperature of the baghouse can be in the range of 50° C. to 250° C. Therefore the filter bags need to be able to function in these operational temperatures. One significant risk associated with some applications is the risk of embers, heated particles or sparks being present in the hopper. In the event that an ember or other hot particle contacts the filter media, a hole can be burned in the filter media severely hampering or completely eliminating its effectiveness. A spark can also create an undesirably opening in the filter bag.

In some applications, the gas includes particles that are heated such as in the coal, chemical, metal industries. These heated particles can contact the filter bag and damage the bag rendered the filtering functionality ineffective. Further, there can be chemicals in the air stream that are corrosive or otherwise damaging to the filter bag itself.

Therefore, it would be advantageous to have a filter bag for a baghouse that was resistant to heated particles and corrosive chemicals while maintaining or improving the performance properties of traditional filter bags.

### SUMMARY OF THE INVENTION

To further the objectives above, this invention provides for non woven filter media comprising: polyphenylene sulfide fibers having a denier between 0.5 and 10.0 and present in an amount between 70% and 80% by weight in said non woven filter media; inorganic fibers having a denier between 0.5 and 6.0, present in an amount between 20% and 30% by weight in said non woven filter media, wherein said inorganic fiber includes at least 90% by weight SiO₂, 4.0% by weight of Al₂O₃; and, said non woven filter media exhibits a clean gas concentration of less than 0.1 mg/m³ and an average cycle time of greater than 125 seconds when the media at 16.0 ounces per square yard is tested per ASTM-D6830-02.

The invention can also include filter media comprising: a first polymer fiber having a denier between 2.5 and 3.0 and present in an amount between 5% and 95% by weight in said filter media and taken from the group consisting of: polyphenylene sulfide, polyester, meta-aramid, para-aramid, acrylic, PTFE, Polyimide, glass, nylon; and, inorganic fibers having a denier between 0.5 and 1.5, present in an amount between 5% and 95% by weight in said filter media, wherein said inorganic fiber includes at least 90% by weight SiO₂, 4.0% by weight of Al₂O₃.

The invention can also include a nonwoven filter media comprising: polyphenylene sulfide fibers present in an amount between 70% and 80% by weight in the filter media; inorganic fibers present in an amount between 20% and 30% by weight in the filter media and wherein the filter media exhibits physical properties taken from the group consisting of: (a) a clean gas concentration of less than 0.1 mg/m³, (b) an average cycle time of greater than 125 seconds when the media at 16.0 ounces per square yard is tested per ASTM-D6830-02, (c) residual pressure drop of less than 350 Pa as measured by ASTM-D6830-02; (d) weight of between 5.0 and 20.0 ounces per square yard and a thickness between 0.020 and 0.100 inches, (e) air permeability of between 10 and 60 cubic feet per minute, (f) Mullen Burst strength of at least 225 pounds per square inch, (g) less than 50% strength loss according to a tensile test after being submerged in sulfuric acid of at least a 6% concentration for at least 30 minutes according to tensile test ASTM-D461-93, (h) total mass removal efficiency of about 99.99% according to ASTM test method D6830-02 and (i) resists burn-through by a stainless steel ball bearings of between about ¼ to ½ inches in diameter, heated at least to 800° C. wherein the heated ball bearing is placed on the filter media that is stretched horizontally across a frame.

### DESCRIPTION OF THE DRAWINGS

The following description is better understood with reference to the incorporated drawings which are part of the description of the invention:

FIG. 1 is a front view of prior art;

FIG. 2 is a cross section of the invention;

FIG. 3 is a cross section of the invention; and,

FIGS. 4A and 4B are test results of the invention.

### DETAIL DESCRIPTION OF THE PRESENTLY PREFERRED EMBODIMENT

This invention relates to a composition of fibers and filter media made there from that provide for advantageous physical properties, especially for use with bag filters for a baghouse. In one embodiment, the fiber composition that can be used for a filter media includes a blend of polyphenylene sulfide fibers that are present in an amount between 70% and 80% in the blended fiber. The denier of these fibers can be between 0.5 and 10.0 and the fiber can be non-woven. An inorganic fiber can also be present in an amount between 20% and 30% by weight. In one embodiment, the inorganic fiber includes at least 90% by weight of SiO₂ and 4.0% by weight of Al₂O₃. The denier of the inorganic fiber can be between 0.5 and 6.0. In one embodiment, the polyphenylene sulfide is present in an amount between 70% and 80% by weight in the filter media. The inorganic fiber is present in an amount between 20% and 30% by weight.

The filter media manufactured from the blended fibers can be used in operational environments that have temperatures in the range between 80° C. and 200° C.

In one embodiment, a first polymer taken from the group of polyphenylene sulfide, polyester, meta-aramid, para-aramid, acrylic, PTFE, Polyimide, glass and nylon is present in a filter media in an amount between 5% and 95% by weight. The first polymer can have a denier of between 0.5 and 10.0. A second inorganic fiber is blended with the first polymer and present in an amount between 5% and 95%. The inorganic fiber can include 90% by weight of SiO₂ and 4% by weight of Al₂O₃. The first polymer can have a denier between 0.5 and 10.0 and the inorganic fiber can have a denier between 0.5 and 6.0. A scrim can be included in the filter media to support the blended fibers.

When the polyphenylene sulfide fibers and the inorganic fibers are blended and used to manufacture a filter media for a bag filter, the resulting filter can have the physical property of clean gas concentration of less than 0.1 mg/m3. This physical property can be determined by the Standard VDI 3926 test criteria (ASTM-D6830-02), with the following parameters: Tank Pressure 5 Bar (4.93 atm); Dust Concentration 5 g/m³; A/C ration of 2; Vale Opening Time 60 seconds; and Temperature of 25° C. (77° F.). With the above test parameter and tested filter media, the following results were achieved as shown in Tables 1 and 2:

TABLE 1
Sample 10.31 g and 546 g/m²

| | | Conditioning | Aging | Stabilizing | Measuring | Measuring |
|---|---|---|---|---|---|---|
| | | 30 cycles | 2,500 pulses | 10 cycles | @ 1,000 | @ 1800 |
| | Start of | pulsing @ | every 20 | pulsing @ | Pa. 2 | Pa, 3 |
| | Test | 1,000 Pa | seconds | 1,000 Pa | hours | hours |
| Mass Filter Holder + | 499.57 | 500.49 | 501.08 | 501.11 | 501.39 | |
| Sample (g) | | | | | | |
| Mass Grain of Filter (g) | 0 | 1.02 | 1.51 | 1.54 | 1.82 | |
| Residual Pressure Drop | 43 | 60 | 235 | 238 | 239 | |
| ΔPᵣₑₛ (Pa) | | | | | | |
| Residual Dust Mass (g/m²) | | 66.23 | 98.05 | 100.00 | 118.18 | |
| Measuring Time tₘ (s) | | 17,360 | 50,000 | 3,424 | 7,310 | |
| Number of Complete Cycles | | 30 | 2500 | 10 | 24 | |
| Average Cycle Time (s) | | 579 | 20 | 342 | 305 | |
| Dust Penetration m_{Abs} (mg) | | 8.8 | 59.3 | −0.1 | 0.3 | |
| Clean Gas Concentration | | 0.987 | 2.310 | −0.057 | 0.080 | |
| C_{c} (mg/m³) | | | | | | |

TABLE 2
Sample 10.24 g and 542 g/m²

| | | Conditioning | Aging | Stabilizing | Measuring | Measuring |
|---|---|---|---|---|---|---|
| | | 30 cycles | 2,500 pulses | 10 cycles | @ 1,000 | @ 1800 |
| | Start of | pulsing @ | every 20 | pulsing @ | Pa. 2 | Pa, 3 |
| | Test | 1,000 Pa | seconds | 1,000 Pa | hours | hours |
| Mass Filter Holder + | 499.51 | 500.18 | 501.23 | 501.20 | 501.15 | |
| Sample (g) | | | | | | |
| Mass Grain of Filter (g) | 0 | 0.67 | 1.72 | 1.69 | 1.64 | |
| Residual Pressure Drop | 42 | 58 | 242 | 228 | 224 | |
| ΔPᵣₑₛ (Pa) | | | | | | |
| Residual Dust Mass (g/m²) | | 43.51 | 111.69 | 109.74 | 106.49 | |
| Measuring Time tₘ (s) | | 18,228 | 50,000 | 2,762 | 7,310 | |
| Number of Complete Cycles | | 30 | 2500 | 10 | 24 | |
| Average Cycle Time (s) | | 608 | 20 | 276 | 305 | |
| Dust Penetration m_{Abs} (mg) | | 9.1 | 99.6 | 0.3 | 0.8 | |
| Clean Gas Concentration | | 0.973 | 3.881 | 0.212 | 0.213 | |
| C_{c} (mg/m³) | | | | | | |

From these results, we can see that the clean gas concentration can be less than 0.1 mg/m³ and the average cycle time can be greater than 125 seconds. The air permeability can be between 10 and 60 ft³/min. The filter media can have a Mullen Burst strength of at least 225 lbs/inch². In one embodiment, the Mullen Burst strength is between 225 and 245 lbs/inch².

In one embodiment, the filter media manufactured from the blended fibers has the physical property of total mass removal of about 99.99% according to test method ASTM D6830-02.

In one embodiment, the nonwoven filter media can be supported by a scrim that can be 1.0 to 6.0 ounces in weight. The weight of the filter media can be between 5.0 and 20.0 ounces per square yard. The filter media can have a thickness between 0.020 and 0.100 inches.

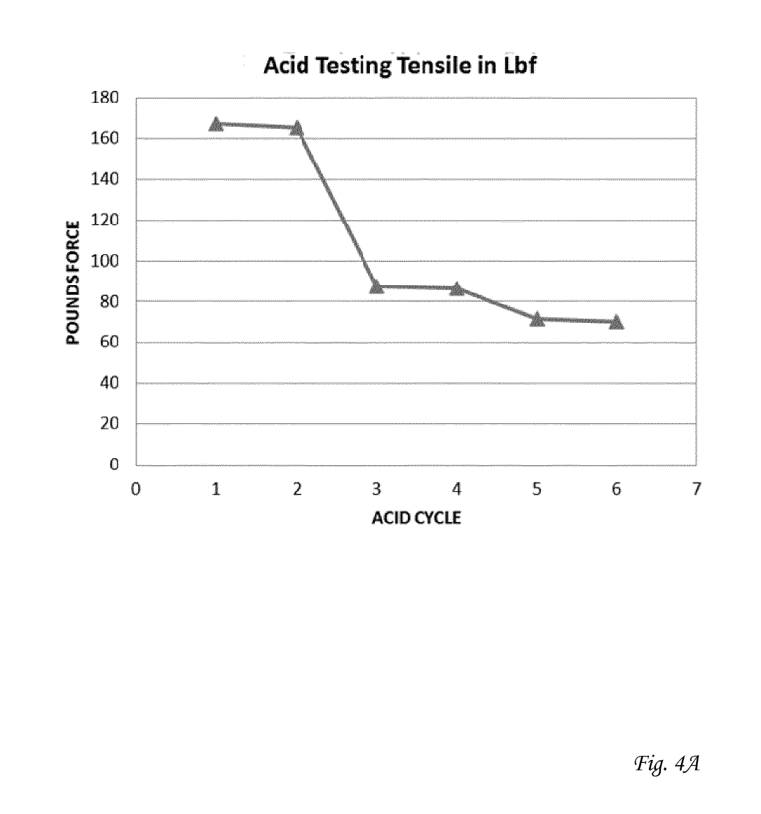

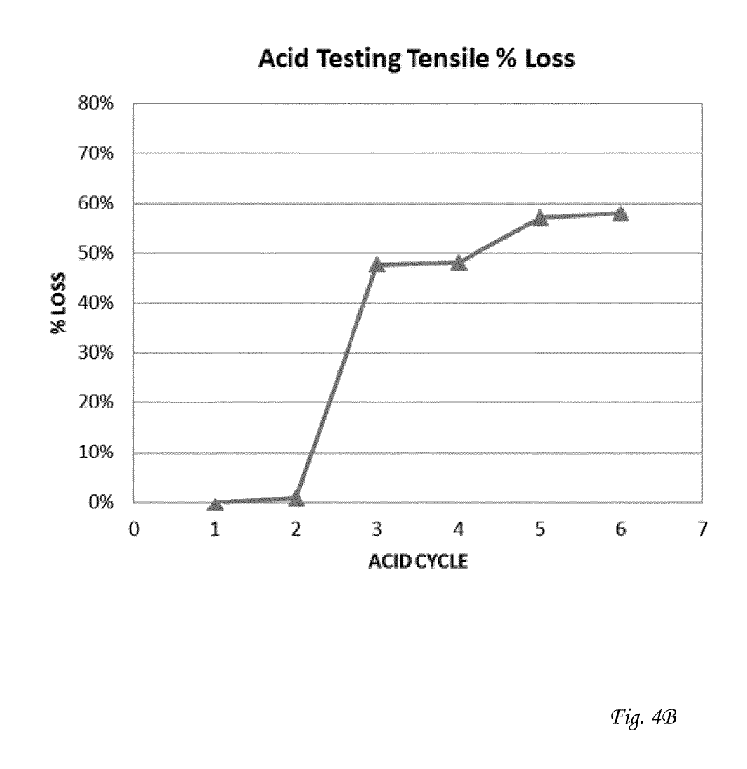

In one embodiment, the blended fibers manufactured into a filter media include the physical property of exhibiting less than a 50% loss in strength using a tensile test after being submerged in 6% sulfuric acid for 30 minutes according to test ASTM-D461-93. In one embodiment, an acid resistance tensile test is preformed with a testing machine suitable for ASTM D5035-95. A sample of the blended fabric is cut into about a 2 inch by 6 inch piece in the machine direction. The specimens are then heated to 400° F. for 4 hours and then the samples are cooled to ambient temperature. The samples are placed in a dish with an acid solution of 1N H₂SO₄ heated to 175° F. for 5 minutes. The samples are then dried hanging in an oven for 5 minutes at 400° F. then cooled to ambient temperature. The process of placing the sample in the 1N H₂SO₄ solution then drying and cooling the sample defines one cycle. The samples are then tested using test method ASTM 5035-95 for strength and elongation with a 50-lbs load. Several of the specimens can be further submerged in 1N H₂SO₄ heated to 175° F. for an addition 5 minutes and then dried hanging in an oven for 5 minutes at 400° F. then cooled to ambient temperature for further testing. Using the acid resistance tensile test, the results are shown in FIGS. 4A and 4B.

From the acid resistance tensile test, it can be seen that after the first two cycles, the sample can withstand over 160 Ids of force. At break, after the third and fourth cycle, the sample can withstand 80 Ids of force. After the fifth and sixth cycles, the sample can withstand about 70 pounds of force. In terms of percentage strength loss, the sample exhibits virtually no loss after the first two cycles. The second and third cycle results in less than 5% strength loss and the fifth and sixth cycle results in less than 60% loss. The following table illustrates the physical property benefit of the present invention when compared to a polyphenylene sulfide (PPS) fiber alone.

TABLE 3

| | |
|---|---|
| Pounds Of | Percentage |
| Force | Strength Loss |

| Cycle | Invention | PPS | Invention | PPS |
|---|---|---|---|---|
| 1 | ~165 | ~140 | 0 | 0 |
| 2 | ~165 | ~135 | 0 | 5 |
| 3 | ~85 | ~40 | 47 | 71 |
| 4 | ~85 | ~38 | 47 | 75 |
| 5 | ~70 | ~39 | 57 | 75 |
| 6 | ~70 | ~38 | 57 | 77 |

Using a stainless steel ball bearing having a diameter of between ¼ and ½ inches and heated to at least 800° C., a sample of the present invention will support the ball bearing when it is placed on filter media stretched horizontally across a frame.

In one embodiment, the polyphenylene sulfide fibers have a length of between 1 and 4 inches and a diameter of between 7 and 36 microns and said inorganic fibers have a length of between 1 and 4 inches and a diameter of between 5 and 20 microns.

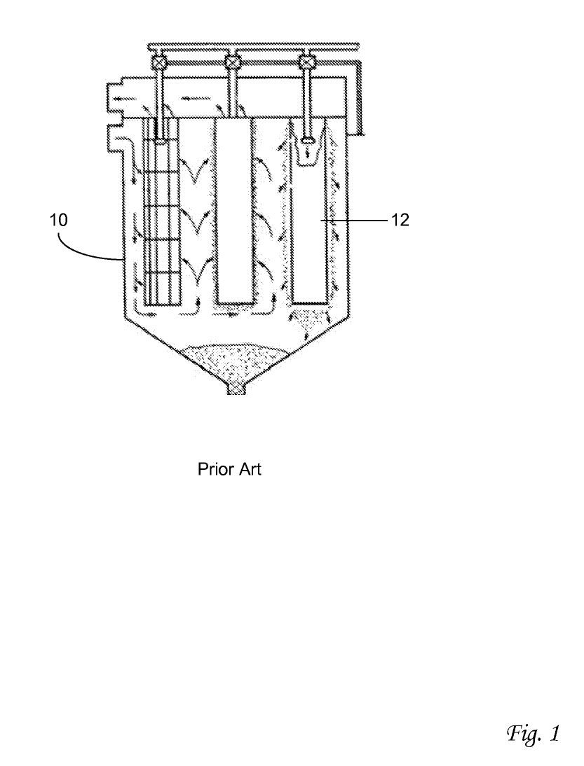

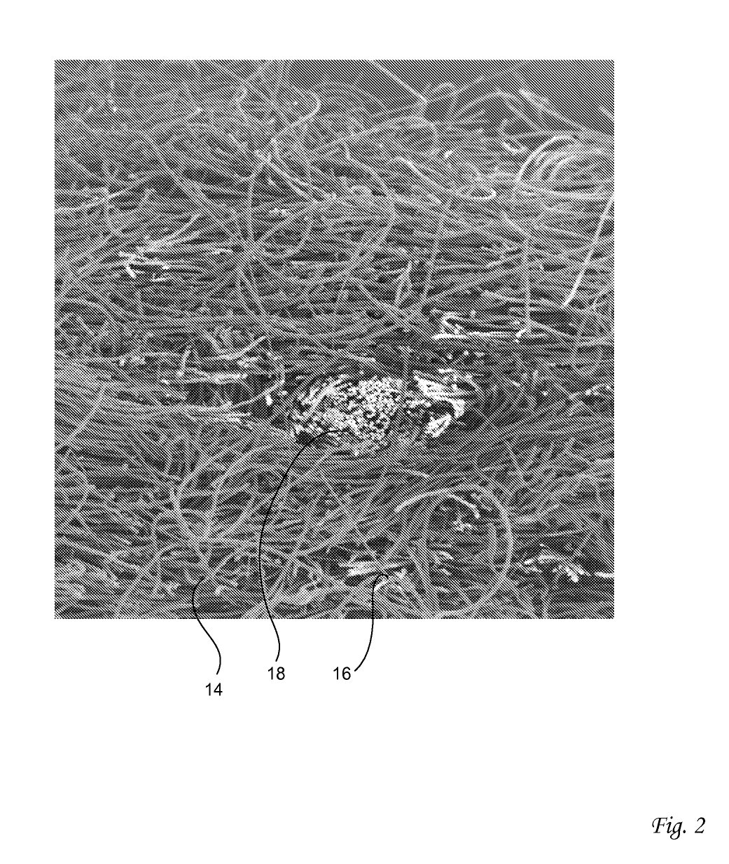

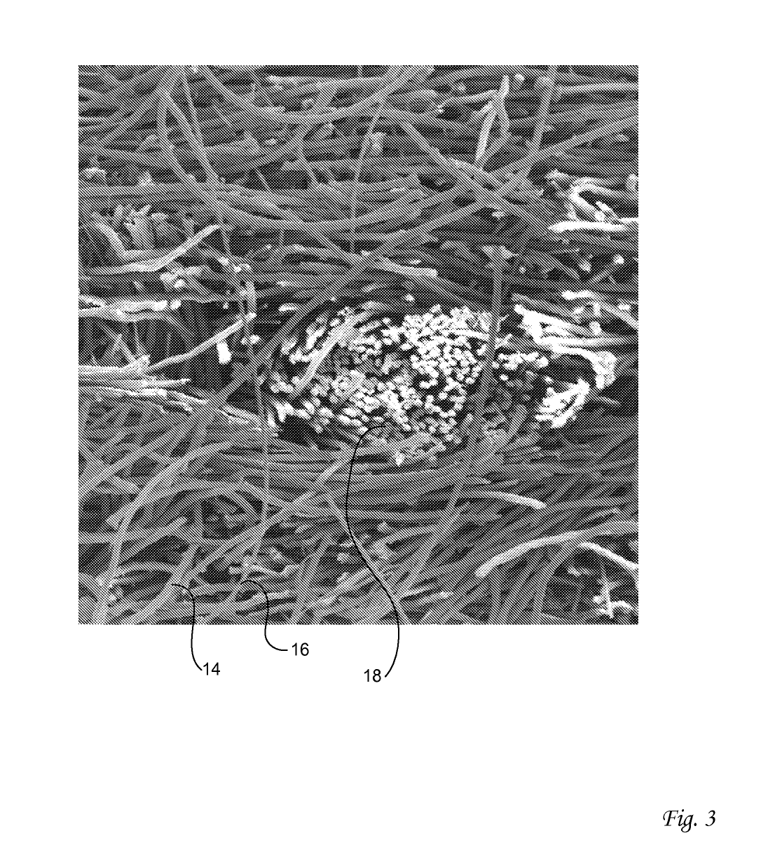

Referring to FIGS. 1 and 2, the blended fibers are shown. The fibers 14 with the larger diameter principally consist of polyphenylene sulfide and the fibers 16 with the smaller diameters are the inorganic fibers. The scrim 18 is also shown disposed in the blend of fibers. The inorganic fibers are blended with the polyphenylene sulfide fibers and supported by a scrim.

What is claimed is:

1. A non woven filter media comprising:
polyphenylene sulfide fibers having a denier between 0.5 and 10.0 and present in an amount between 70% and 80% by weight in said non woven filter media;
inorganic fibers having a denier between 0.5 and 6.0, present in an amount between 20% and 30% by weight in said non woven filter media, wherein said inorganic fiber includes at least 90% by weight SiO₂, 4.0% by weight of Al₂O₃; and,
said non woven filter media exhibits a clean gas concentration of less than 0.1 mg/m³ and an average cycle time of greater than 125 seconds when the media at 16.0 ounces per square yard is tested per ASTM-D6830-02.

2. The nonwoven filter media of claim 1 including a scrim supporting said filter media.

3. The nonwoven filter media of claim 2 wherein said scrim is a 1 to 6 ounce scrim.

4. The nonwoven filter media of claim 1 wherein said filter media has a weight of between 5.0 and 20.0 ounces per square yard, a thickness between 0.020 and 0.100 inches, air permeability of between 10 and 60 cubic feet per minute and Mullen Burst strength of at least 225 pounds per square inch.

5. The nonwoven filter media of claim 1 wherein said filter media exhibits less than 50% strength loss according to a tensile test after being submerged in sulfuric acid of at least a 6% concentration for 30 minutes according to tensile test ASTM-D461-93.

6. The nonwoven filter media of claim 1 wherein said filter media exhibits less than 50% strength loss according to a tensile test after being submerged in sulfuric acid having a concentration between 5.0% and 7.0% for between 0 and 30 minutes according to tensile test ASTM-D461-93.

7. The nonwoven filter media of claim 1 wherein said polyphenylene sulfide fibers have a length of between 1 and 4 inches and a diameter of between 7 and 36 microns and said inorganic fibers have a length of between 1 and 4 inches and a diameter of between 5 and 30 microns.

8. The nonwoven filter media of claim 1 wherein said filter media exhibits a total mass removal efficiency of about 99.99% according to ASTM test method D6830-02.

9. The nonwoven filter media of claim 1 wherein said filter media resists burn-through by a stainless steel ball bearings of between about ¼ to ½ inches in diameter, heated at least to 800° C. wherein said heated ball bearing is placed on said filter media that is stretched horizontally across a frame.

10. The nonwoven filter media of claim 1 wherein said filter media exhibits a residual pressure drop of less than 350 Pa as measured by ASTM-D6830-02.

11. A filter media comprising:
a first polymer fiber having a denier between 0.5 and 10.0 and present in an amount between 5% and 95% by weight in said filter media and taken from the group consisting of: polyphenylene sulfide, polyester, meta-aramid, para-aramid, acrylic, PTFE, Polyimide, glass, nylon; and inorganic fibers having a denier between 0.5 and 6.0, present in an amount between 5% and 95% by weight in said filter media, wherein said inorganic fiber includes at least 90% by weight SiO₂, 4.0% by weight of Al₂O₃.

12. The filter media of claim 11 including a scrim supporting said first polymer fiber and said inorganic fibers.

13. The filter media of claim 11 wherein said filter media includes physical properties taken from the group consisting of: (a) weight of between 5.0 and 20.0 ounces per square yard, (b) thickness between 0.020 and 0.100 inches, (c) air permeability of between 10 and 60 cubic feet per minute and (d) Mullen Burst strength of at least 225 pounds per square inch.

14. The filter media of claim 11 wherein said filter media exhibits less than 50% strength loss according to a tensile test after being submerged in sulfuric acid solution of at least 6% concentration for at least 30 minutes.

15. The filter media of claim 11 wherein said tensile test is preformed according to tensile test ASTM-D461-93.

16. A nonwoven filter media comprising:
polyphenylene sulfide fibers present in an amount between 70% and 80% by weight in said filter media;
inorganic fibers present in an amount between 20% and 30% by weight in said filter media and
wherein said filter media exhibits physical properties taken from the group consisting of: (a) a clean gas concentration of less than 0.1 mg/m³, (b) an average cycle time of greater than 125 seconds when the media at 16.0 ounces per square yard is tested per ASTM-D6830-02, (c) residual pressure drop of less than 350 Pa as measured by ASTM-D6830-02; (d) weight of between 5.0 and 20.0 ounces per square yard and a thickness between 0.020 and 0.100 inches, (e) air permeability of between 10 and 60 cubic feet per minute, (f) Mullen Burst strength of at least 225 pounds per square inch, (g) less than 50% strength loss according to a tensile test after being submerged in sulfuric acid of at least a 6% concentration for at least 30 minutes according to tensile test ASTM-D461-93, (h) total mass removal efficiency of about 99.99% according to ASTM test method D6830-02 and (i) resists burn-through by a stainless steel ball bearings of between about ¼ to ½ inches in diameter, heated at least to 800° C. wherein said heated ball bearing is placed on said filter media that is stretched horizontally across a frame.

17. The nonwoven filter media of claim 16 wherein said inorganic fiber includes at least 90% by weight SiO₂, 4.0% by weight of Al₂O₃.

18. The nonwoven filter media of claim 16 including a scrim supporting said first fibers and said inorganic fibers.

19. The nonwoven filter media of claim 16 wherein said filter media for use in operational environments between 80° C. and 200° C.

20. The nonwoven filter media of claim 16 including a first layer and a second layer of nonwoven filter media supported by a scrim.

21. The nonwoven filter media of claim 16 that is laminated with a PTFE membrane.

22. The nonwoven filter media of claim 16 that is chemically treated.

23. The nonwoven filter media of claim 16 that has two or more fibers blended with the inorganic fiber.
